(19) United States
(12) Patent Application Publication
(10) Pub. No.: US 2008/0138551 A1
(43) Pub. Date: Jun. 12, 2008

(54) Product Packaging and Closure System and Product Holder Incorporating Cling Polymer

(76) Inventor: Alexandra Gordon, Bedford, NY (US)

Correspondence Address: DORITY & MANNING, P.A., POST OFFICE BOX 1449, GREENVILLE, SC, 29602-1449, US

(21) Appl. No.: 11/869,412

(22) Filed: Oct. 9, 2007

Related U.S. Application Data
(63) Continuation-in-part of application No. PCT/US2006/012723, filed on Apr. 6, 2006.
Application No. PCT/US2006/012723 is a continuation-in-part of application No. PCT/US2005/030204, filed on Aug. 25, 2005.
(60) Provisional application No. 60/668,813, filed on Apr. 6, 2005.

(51) Int. Cl. B29D 22/00

(52) U.S. Cl. 428/35.7

(57) ABSTRACT

The present invention relates generally to holders for products, and to packages including holders and products, wherein the holder incorporates a cling polymer to non-adhesively hold the product in place, as well as closures and systems incorporating such cling polymers.

### RELATED APPLICATIONS

This application claims the benefit of and is a continuation-in-part of co-pending PCT International Application No. PCT/US05/30204, filed Aug. 25, 2005, and PCT International Application Serial No. PCT/US06/012723, filed Apr. 6, 2006, and also claims the benefit of U.S. Provisional Patent Application Ser. No. 60/668,813, filed Apr. 6, 2005, U.S. Provisional Patent Application Ser. No. 60/732,445, filed Nov. 1, 2005, via the PCT applications, all four applications being incorporated by reference herein for all purposes.

### FIELD OF INVENTION

The present invention relates generally to holders for products and to a system for the non-adhesive fugitive restraint of products in packaging and product holders, wherein the holder or package incorporates a cling polymer which both holds the product in place and to which products may be readhered, as well as non-adhesive closure systems incorporating cling polymers, wherein closures are resealable.

### BACKGROUND OF INVENTION

Data storage media, such as CDs, CD-ROMs, and DVDs, require careful handling and protection. Typically, such media is in the form of polycarbonate discs, which are typically manufactured with one recorded side and one printed side. Scratches or other damage to the recorded side can render such media unreadable.

Various types of protective devices for such data storage media have been proposed. For example, “jewel boxes,” cardboard sleeves, and the like have been used to package and protect data storage media. CD jewel boxes typically have two parts pivotally connected (a base and a lid), with a flexible, round hub with multiple arms provided on the inside of the base. A circular opening through the center of a disc can be pushed onto the flexible hub to hold the disc in place. Other similar structures have been incorporated into cardboard packaging for CDs, and DVDs have also been packaged using similar structures. While these devices are somewhat effective for many purposes such as retail sales, the devices suffer from certain drawbacks.

For example, such devices are relatively bulky and expensive. In particular, such devices may not be suitable for various promotional, distributional, or storage uses. Thus, it may not be practical to distribute promotional CD's via mail or within mailed magazines using such conventional devices. Further, storage of many discs in one location can require a much larger amount of space than is called for simply by the discs themselves. Also, such devices may not provide a secure protection and/or covering of the recorded sides of such media. Moreover, such devices are easily damaged or destroyed in use, rendering impossible their repeated use to hold or store data storage media. Accordingly, one or more new data storage media holders and packages incorporating such media, addressing one or more drawbacks of conventional devices such as those listed above or others would be welcome.

Products other than data storage media are packaged in diverse ways, depending for example on the characteristics of the product, its use, its life cycle, how it is sold or marketed, etc. The packaging may be used for promotional, sale, carrying or protective purposes. The packaging industry is generally interested in packaging simplifications and improvements, for example to save money, reduce waste, and/or provide a re-usable package or to create a more esthetically pleasant presentation of products. Fugitive glue is a common method used to hold products in packaging. However, products held in place within their packaging by fugitive glue, may retain the glue upon removal of the product from the package, and fugitive glue does not permit the repositioning or readherance of the product to the substrate or package once initially affixed. Furthermore, upon removal of products from packaging the fugitive glue itself comprises an inelegant and unsightly residue, which must be manually removed, and is an annoyance to many consumers. The application of adhesives also carries with it a risk of messiness, spillage, unevenness, or placement of adhesive in a location other than what is desired. This has the effect of slowing production and creating waste (whether the manufacturing process is manual or highly automated). Cast or laminated co-adhesive constructions (such as found attached to consumer goods in the form of on-pack coupons, recipes or other data) peel away cleanly, however cannot be re-adhered. Accordingly, improved packaging for products and packaged product configurations, which can provide an esthetically pleasant or elegant presentation, without stickiness or residue, and provide the added functionality for either consumers or in the manufacturing process, of allowing the repositioning or readherance of products would be welcome in the broad scope of goods beyond storage media as well.

The challenge to provide more generally a method for closure of packaging and/or retention of one product or substrate to another has found a variety of solutions over time. These solutions have ranged from flaps and slits, ties, buttons and mechanical closures to Velcro™, and include a vast array of adhesives. Permanent adhesives, however, while providing retention, are not releasable or resealable. Fugitive and low tack adhesives, while releasable, are sticky and comprise an undesired residue. Velcro™, clasps and various mechanical closures are bulky and may be unwieldy, visually undesirable or too expensive. Flaps, slits and other friction fit forms of closure or retention are cumbersome, may be unreliable in use, and often require expensive and time consuming hand-assembly. Accordingly, improved packaging closure and retention solutions which offer esthetic improvements, without stickiness, residue or bulkiness, and which are resealable would also be welcome.

### SUMMARY

According to certain aspects of the invention, a holder is disclosed for a product, the holder including a substrate; and a cling polymer layer permanently attached to at least a portion of the substrate, the cling polymer layer having an outer surface defining a target area configured for releasably securing the product to the substrate via a non-adhesive, cling hold to the cling polymer layer. The cling polymer layer includes a plasticizer and has a smooth finish in at least the target area without tactile stickiness, whereby the product may be repeatedly pressed onto and removed from the target area. The cling polymer layer non-adhesively secures the product to the substrate for handling as a unit, and is configured such that removal of the product from the cling polymer layer does not produce tactile residue on either the product or the substrate. Various options and modifications are possible.

For example, the substrate may be eliminated from the above. Also, the cling polymer layer may include a vinyl or a polyester. The cling polymer layer may also be at least partially translucent or transparent, whereby the substrate is at least partially visible through the cling polymer layer. The substrate may include graphical material and the product may be releasably positioned in reference to the graphical material via the cling polymer, whereby removal of the product reveals the graphical material. Removal of the product may complete a visual message. Also, the product and the substrate may include graphical material configured to co-operatively form a single presentation when the product is attached to the target area in a predetermined orientation.

If desired, only the cling polymer layer may be used to secure the product to the substrate. The substrate may define a three-dimensional shape configured for receiving the product and protecting an outer edge of the product holder. The product and the cling polymer layer material may separate in a 180 degree peel force test initially at about 15 grams and after dwell time at as much as 50 grams or more.

The substrate may include one of a direct mail brochure, a flat or folded card, or a book, magazine or publication insert, page or cover. The product may include a first side for contacting the cling polymer target area and a second side opposite the first side, and the substrate may include a portion configured to contact the product on the second side. The substrate may comprise one or more of an envelope, a folder, a binder, a flat member having an overlay, a pocketed member, a slit member, a lid, a box, or other container. The cling polymer layer may hold the portion of the substrate in place relative to the product as a closure.

The product may comprise an optical disc or a plastic or plasticized card such as a credit card, ID card or gift card, or an item held during a commercial process.

In accordance with other aspects of the invention, the above holders may be combined with any suitable products to achieve a package including the holder and the product.

Other aspects of the invention include a holder for a product, the holder including a cling polymer layer, the cling polymer layer being at least partially translucent or transparent and having a first surface defining a target area configured for releasably securing to the product via a non-adhesive, cling hold to the cling polymer layer. The cling polymer layer includes a plasticizer and has a smooth finish in at least the target area without tactile stickiness, whereby the product may be repeatedly pressed onto and removed from the target area, the cling polymer layer non-adhesively securing the product to the substrate for handling as a unit. The cling polymer layer is configured such that removal of the product from the cling polymer layer does not produce tactile residue on either the product or the substrate. A first graphical layer is disposed on a second surface of the cling polymer layer. A flood layer is disposed on and provides a visual backing for the first graphical layer so that the first graphical layer is readable only through the first surface of the cling polymer layer when the cling polymer layer is removed from the product. A second graphical layer is disposed on the flood layer visible from the second surface of the cling polymer layer, whereby opposite sides of the holder may provide different graphical messages via the first and second graphical layers, visually separated by the intervening flood layer. Again, various options and modifications are possible.

According to other aspects of the invention, a package includes a substrate having a body and a movable portion, the movable portion movable between an opened and a closed position, and a cling polymer layer permanently attached to at least a portion of at least one of the body or the movable portion, the cling polymer layer having an outer surface defining a target area configured for releasably securing the movable portion to the body via a non-adhesive, cling hold to the cling polymer layer. The cling polymer layer includes a plasticizer and having a smooth finish in at least the target area without tactile stickiness, whereby the movable portion may be repeatedly pressed onto and removed from the target area. The cling polymer layer non-adhesively secures the movable portion to the body as a closure, the cling polymer layer configured such that opening of the closure layer does not produce tactile residue on either the movable portion or the body. Again, various options and modifications are possible.

### BRIEF DESCRIPTION OF THE DRAWINGS

The above and other aspects and advantages of the present invention are apparent from the detailed description below and in combination with the drawings in which:

FIG. 1 is a perspective view of a first embodiment of a holder and package for a data storage medium according to certain aspects of the present invention.

FIG. 2 is a perspective view of the holder of FIG. 1, with the data storage medium removed from the holder.

FIG. 3 is a cross-sectional view of a portion of the package of FIG. 1 taken along line 3-3, showing one possible combination of features.

FIG. 4 is a top view of the holder of FIG. 1 showing one possible orientation of a target area on a substrate.

FIG. 5 is a top view of an alternate holder, showing an alternate continuous target area.

FIG. 6 is a top view of an alternate holder, showing an alternate segmented target area.

FIG. 7 is a top view of an alternate holder, showing a plurality of target areas on a single substrate.

FIG. 8 is a perspective view of an alternate holder, showing a plurality of target areas on a plurality of substrates.

FIG. 9 is a top view of an alternate holder, showing a single graphical presentation across a data storage medium and a substrate and/or polymer layer.

FIG. 10 is a perspective view of an alternate holder, showing a cling polymer layer releasably attachable to a substrate and an optional tab and recess structure for assisting in removal.

FIG. 11 is a cross-sectional view of a portion of an alternate holder, showing an additional layer contacting the second side of the data storage medium.

FIG. 12 is a cross-sectional view of an alternate holder, showing a wall formed in the substrate for surrounding an edge of the data storage medium.

FIG. 13 is an enlarged cross-sectional view of a portion of a modified version of the holder of FIG. 12.

FIG. 14 is a cross-sectional diagrammatical view of a substrate, a cling layer, and a product according to broad aspects of the invention.

FIG. 15 is a perspective view of a first example of one application of the concepts of FIG. 14, wherein a product comprising a portable music player is attached to a holder.

FIG. 16 is a cross-sectional view of an example of a holder and product wherein the cling polymer layer is pre-formed to be non-planar.

FIG. 17 is a cross-sectional view of an example of a holder and product wherein the cling-polymer layer is non-planar, as formed via contact with the product, shown before contact.

FIG. 18 is a cross-sectional view of an example of the holder and product of FIG. 17, shown after contact.

FIGS. 19-22 are cross-sectional views of four examples of a package with a flap and cling material acting as a closure.

FIGS. 23-26 are respectively enlarged portions of FIGS. 19-22 FIGS. 27 and 28 show cross-sectional views of one possible modification to the packages of FIGS. 19-26, employing a variably attachable flap.

FIG. 29 is a top view of one example of a product holder using cling polymer.

FIG. 30 is an exploded perspective view of the holder of FIG. 29.

FIG. 31 is a top view of another alternate product holder using a cling polymer overlay.

FIG. 32 is an exploded perspective view of the holder of FIG. 31.

FIG. 33 is a perspective view of a modification of the holder of FIGS. 31 and 32.

FIG. 34 is a top view of a product holder with an optical disc thereon, secured by cling polymer.

FIG. 35 is a top view of the holder of FIG. 34, with the disc removed.

FIG. 36 is a top view of the holder of FIG. 35, from the opposite side as in FIG. 35.

FIG. 37 is across sectional view of the holder and disc of FIG. 34.

FIG. 38 is a perspective view of a closed holder, sealable via a cling polymer.

FIG. 39 is a perspective view of the holder of FIG. 38, in an opened orientation showing an optional product therein.

### DETAILED DESCRIPTION

Detailed reference will now be made to the drawings in which examples embodying the present invention are shown. The drawings and detailed description provide a full and detailed written description of the invention, and of the manner and process of making and using it, so as to enable one skilled in the pertinent art to make and use it, as well as the best mode of carrying out the invention. However, the examples set forth in the drawings and detailed description are provided by way of explanation of the invention and not meant as a limitation of the invention. The present invention thus includes any modifications and variations of the following examples as come within the scope of the appended claims and their equivalents.

The detailed description uses numerical and letter designations to refer to features in the drawings. Like or similar designations in the drawings and description have been used to refer to like or similar parts of the invention.

The present invention relates generally to holders and closures as may be used at least:

1) to close or restrain any form of packaging, media or product including any part thereof, be it any size, shape, or material composition, comprising a contiguous object or a multi-piece construction designed to function as a unit, including envelopes, boxes, bags, folders, books, notebooks, wallets, tags, hang-tags, tubes, cups and lids as well as other containers, restraining it to itself or to any other surface;

2) to hold or otherwise restrain objects, components, products or any form of data (either printed, digital or electronic, in a single layer, layered or composite constructions) including constructions combining data and non-data elements, in, on or with any form of packaging or in targeted placement in, on or with any type of product, including signage; and

3) to close, hold or otherwise restrain (as per above) in a releasable/reaffixable, releasable/non-reaffixable, releasable/fugitively affixed or permanently adhered targeted placement, wherein a cling polymer, such as what is commonly called cling vinyl, is incorporated.

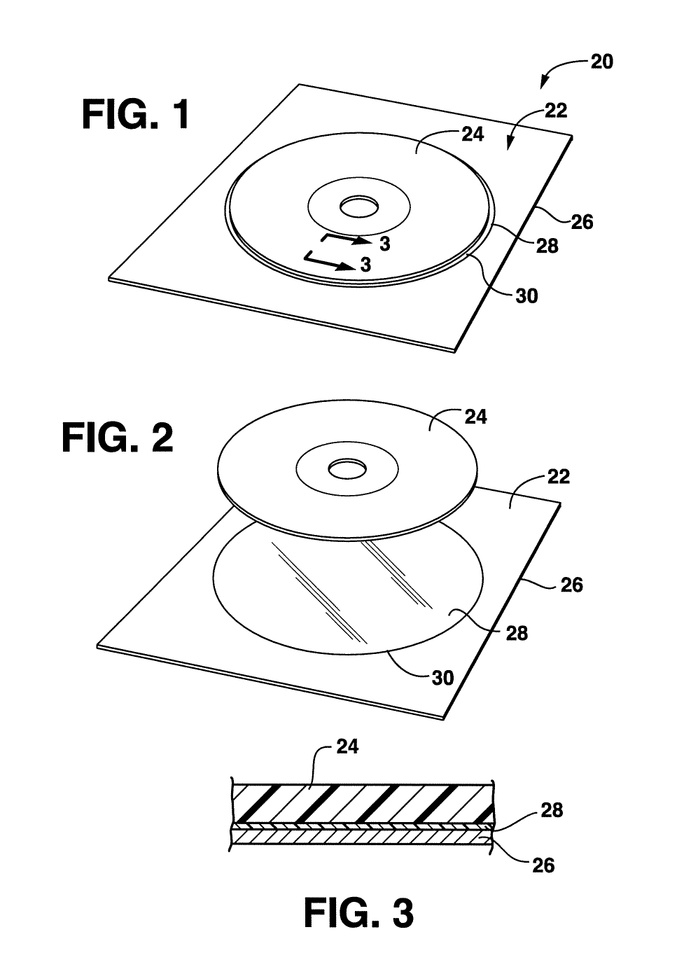

As broadly embodied in FIGS. 1-4, one example is disclosed of a package and holder for a data storage medium according to certain aspects of the present invention. As shown therein, package 20 includes holder 22 and data storage medium 24.

It should be understood that data storage medium 24 may be any known or future type of data storage device, such as optical, magnetic, flash memory or other types of storage devices. The types of data to be stored are also unlimited within the scope of the inventive concepts.

For example, data storage media could be conventional discs that either hold content (i.e.: sounds, images and/or data as distributed on various compact disc (CD) and DVD variations) or are recordable (e.g.: CD-Rs and DVD-Rs). Such discs are typically manufactured using polycarbonate, and include (but are not limited to) forms of optical discs in varying sizes such as 80 mm or 120 mm, and which may be round or any other regular or irregular shape. The present invention is thus not limited to packaging for any type, size, shape, or form of media and/or disc, digital or analog, printed or recorded using any medium now known or yet to be invented, manufactured using any material, including those not yet invented, and here hereafter collectively referred to as “data storage medium,” “data storage media,” “disc media,” “media disc,” or simply “disc.”

Similarly, holder 22 may be any type of substance suitable for supporting the associated data storage medium, for the particular application. Thus, holder 22 may take many disparate forms according to the scope of the various inventive concepts.

For example, holder 22 may incorporate a substrate 26 and a polymer layer 28, in some applications, and a target area 30 for placement of data storage medium 24. It should be understood that substrate 26 may have various sizes and shapes, from those tightly conforming to the outer shape of data storage medium 24 to those larger in various ways. Substrate 26 may incorporate a single continuous polymer layer 28 for a single data storage medium, or may incorporate multiple polymer layers, either for multiple data storage media or in a segmented orientation for a single data storage medium, as will be described below.

Thus, substrate 26 may be made of any suitable manmade or natural material(s), such as paper, plastic, cardboard, magazine stock, card stock, metal, glass, ceramic or combinations thereof, whether having a clear, opaque, glossy, matte, or printed finish. Substrate 26 may also be flat, folded, textured, molded in shape, or it may be an envelope, binder, cover, pocketed member, slit member, or inner or exterior surface of a box, or the like. In one aspect of the present invention, substrate 26 may be shaped coordinately with the data storage medium which it receives, for instance in the case of a standard 120 mm CD or DVD, circular in shape, at 120 mm or greater in diameter. Alternately, substrate 26 may be square or rectangular, with side 120 mm or greater. Holder 22 of FIGS. 1-4 shows such a square example for substrate 26.

Polymer layer 28 may have various forms. For example, in one embodiment polymer layer 28 may be a “cling polymer,” such as cling vinyl or cling polyester. Such materials are sometimes called “static cling polymers” or “static cling vinyl”, although such term is perhaps a misnomer as static electricity is not required. In fact, it is believed that the phenomenon achieved by the materials and products described herein is not “static cling,” per se. Static cling is believed to be caused, for example, by the rubbing of two materials together, wherein the rubbing causes transfer of electrons from one material to the other. The electron transfer may cause a difference in charge between two items, leading to an electronic attraction between the items at the molecular level. This can arise, for example, in shoes walking across a carpet. Also, static cling may be illustrated when, for example, piece of shrink wrapped plastic “sticks” to a CD jewel box after unwrapping. That attraction is believed to be actual static cling, caused by movement of electrons thereby causing a charge imbalance.

In contrast, the present disclosure is directed to the use of a cling polymer that attaches in a non-adhesive cling manner, not using static cling attraction as defined above. It is believed that the cling that occurs is a non-chemical, non-adhesive electron-sharing form of attraction. This attraction may be due to molecular polarity, and may include some aspect of Van der Waals' forces. But the phenomenon is not believed to include or be dominated by the static cling concept of electron transfer, discussed above. Therefore, no rubbing or other preparation of the cling polymer or product to electrically charge either or both is required. The product is simply pressed onto the smooth, soft surface of the cling polymer and is held in that position by the cling polymer.

If polymer layer 28 is in fact a cling polymer, such layer may be a cling vinyl formulated from polyvinyl chloride (PVC) and plasticizer (a liquid), such as those commercially available from vendors such as FLEXcon, Inc., of Spencer, Mass. (Products including FLEXmark CV 700 CLEAR V-402 150 POLY H-9), Ritrama, Inc., of Minneapolis, Minn. (Products no. 3-1550, 3-1321, or 3-1322, “Gloss clear static cling non-topcoated vinyl”); Plastiprint, Inc., of Lakewood, Colo. (“Static Cling Vinyl”); and Grafix® Plastics, Inc. of Cleveland, Ohio (“Static Cling Vinyl Film”). A suitable plasticizer for cling polymers is dioctyl phthalate or trioctyl trimellitates. Such plasticizers can provide or enhance the adhesion of the cling polymer. Cling vinyl has a smooth finish and adheres firmly to any clean, smooth, glossy surface such as glass, metals, and various plastics, including polycarbonate, and other surfaces. Cling polyesters are also suitable for polymer layer 28. Further, any other polymer substance or other substance that could be applied to or serve as a substrate, whereby releasable securement with the data storage media described herein could be used. Use of such cling material is advantageous as it does not leave adhesive or sticky residue on the disc, while at the same time being very pliable and bendable, facilitating easy removal. An important advantage is that the securing capability of cling polymers is not measurably reduced with repeated use. Therefore, the disc can be removed for use and replaced repeatedly. The disc may thus be protected between the times when it is being used: during the time it is shuffled on desks, tucked into pockets, briefcases, back-packs and handbags, stacked, filed, and otherwise handled.

As cling adhesion relies on plasticizer content for its power to retain or adhere, the relative amount of plasticizer (as well as the selection of the plasticizer used) as well as other variables may be varied in order to create various performance characteristics. Examples of plasticizers in cling polymer products include Dioctyl Phthalate, Di-sec-octyl phthalate; DOP; Bis(2-Etheylexyl) Phthalate; Bis(2-Ethylhexyl) Phthalate; Benzenedicarboxylic acid, bis(2-ethylhexyl)ester; 1,2-Benzenedicarboxylic acid bis(2-ethylhexyl)ester; Octoil; Ethyl hexyl phthalate; 2-Ethylhexyl phthalate; Di-sec-octyl phthalate; DEHP; Octyl phthalate; phthalic acid dioctyl ester; BEHP; and Trimellitate Esters, including Trioctyl Trimellitate, and others. Such performance characteristics of cling polymers which may be modified to achieve desired qualities include varying the degree of strength in the cling polymer's adherence (to a target which may also be a cling polymer, a non-porous surface or any other material, including porous, textured, smooth or dimensional surfaces), varying the cling polymer's ability to adhere to substrates which are variably more or less porous, clean or flat; varying the cling polymer's own smoothness or texture, thickness or “stickiness”; varying the cling vinyl's characteristics as may relate to decomposition in the environment and other environmental values, varying the amount of dwell time required for the cling polymer to attain a desired degree of hold to the target, or the degree to which the cling polymer's surface retains cling properties, or altering the cling polymer's functional life span; or altering the cling polymer's ability to maintain or attain desired performance characteristics as may be affected by time, temperature, exposure, or any type of storage, environmental condition or handling.

As shown, polymer layer 28 is disposed as a film or layer on at least a portion of the surface of the substrate, such as the target area 30 for receipt of data storage medium 24. Target area 30, whether formed continuously or in segments, covers an area large enough, in proportion to data storage medium 24, so that application of the medium to the target area results in the retention of the medium to the target area. Thus, target area 30 may be less than, equal to, or greater in size than a disc that it will receive. By holding the disc to the target area, whether all or only a portion of the disc surface is in direct contact with the cling polymer, coverage and protection to the entire media side of the disc is provided, as shown in FIGS. 1-4. If desired, the polymer layer 28 may be disposed on the entire surface of substrate 26, whether the substrate is circular and sized to match a disc, or is smaller than or larger than the disc in some way. If desired, substrate 26 may have polymer layers 28 on opposite sides. Thus, the target area 30 may or may not be substantially commensurate in size with the substrate 26, or with the size of the media or product being held. Alternatively, target area 30 may be comprised of segments or areas of polymer layer 28, the sum of which is sufficient to hold the disc in place. (See FIG. 6). Data storage medium 24 should be held on target area 30 firmly enough to stay in place but easily removable when desired. Thus, utilizing materials providing a 180 degree peel test value of about 50 to about 200 grams is believed to provide firm enough hold for most applications. More particularly, a peel test value of about 80 to about 188 grams may provide reliable performance, and a value of about 150 to about 180 grams may be suitable for other applications. As discussed below, the initial peel test value may be lower upon application and may increase with dwell time.

Any suitable adhesive (not shown) to attach polymer layer 28 to the substrate 26 may be used in the present invention. If desired, V402 adhesive available from FlexCON, Inc., of Spencer, Mass., may be used to adhere a vinyl polymer layer to a substrate. This adhesive has a 180 degree peel test value of approximately 800 grams (within the range which is typical of the force associated with permanent adhesives). It is clear and plasticizer-resistant. If desired, the adhesive and polymer layer 28 may be formed translucent, to allow graphical material on substrate 26 to be displayed. Alternately, polymer layer 28 may it self include graphical material.

Optionally, a low tack adhesive may be disposed on at least a portion of the surface of substrate 26, thereby forming target area 30 for receipt of data storage medium 24. Target area 30 thus should have a capability to rapidly and reliably bond to the delicate “media side” of discs. This is true whether target area 30 comprises substrate and/or construction utilizing cling polymer, adhesive, or combination of cling polymer and adhesive. For successful bonding to polycarbonate discs (e.g., CDs) the tack or ‘stickiness’ of the polymer, adhesive, and/or combined polymer/adhesive surface is controlling. Tack, or the ability to form a bond to a surface after brief contact under light pressure, can depend on many different factors, including dwell time and age of materials (especially as affected by plasticizer migration). Therefore bonding and debonding strengths for given materials will vary.

If an adhesive is used to enhance the tack, the adhesive may be disposed directly on substrate 26, or it may be the property of a layer of plastic, vinyl or other material (shown here as polymer layer 28). Such plastic, vinyl, or other material has two sides: one with a light tack bond, which is to removably adhere to the disc, while the other side has either a permanent adhesive (in which case, the adhesive/film construction is not removable from substrate 26), or it may have a removable adhesive (which allows removal of the film from substrate 26 to function as a carrier for the disc and to provide protection to the media-side of the disc), or it may be the top layer of a two-ply dry-release construction in which the top layer releases its cohesive bond from the bottom layer, the other side of which remains adhered to the substrate. If the dry-release construction is used, the ply still remaining on the disc can function as a carrier and protect the media side, as above. It should be understood that adhesives are not illustrated in the accompanying figures because their relatively small thicknesses make illustration impractical, but they are understood to be present in the locations described herein. It should also be understood that constructions may comprise multiple layers, integrating any number and any combination of cling-to-cling layers (which are non-adhesively attached), with cling-to-non/cling layers (which are adhesively attached)

The releasable adhesive located in target area 30, contiguously or in segments, retains the disc in the target area, yet allows the disc to be removed or peeled away from substrate 26 (or composite of substrates) for use. While it may be desirable in many applications for target area 30 to be equal to or greater in size than the disc which it will receive (so as to provide contact with and protection to the entire media side of the disc) the actual area of contact can be minimal, as long as it results in the disc's retention.

If desired, polymer layer 28 may be employed, using a cling polymer disposed on at least a portion of the surface of substrate 26, the polymer layer being coated or otherwise combined with a low viscosity or other form of releasable adhesive or adhesive construction. Thus, holder 22 would incorporate a composite product having both the properties of cling polymers combined with one or more adhesive(s), e.g.: cling/adhesive composite products such as those commercially available from vendors such as HPS, LLC, of Rhome, Tex. (products including “Ultra Cling Vinyl”, “Ultra Cling Polyester”, “Cling Tack Media” and other products utilizing “microspear technology”), or as manufactured by FLEXcon, Inc., of Spencer, Mass. (products including FLEXmark® cling vinyl with low-tack/removable adhesive V314), or Ritrama, Inc. (product number 3-5753—2 mil clear polyprop—84×4 low tack/low peel adhesive on a 90# liner).

Alternatively, a multi-ply construction including two or more layers of “dry-release” materials may be utilized. In such case, an adhesive bond is formed on one side of the material (contacting either the data storage medium or a cling polymer layer). The bond on the other side of the multi-ply construction, adhering it to the substrate, may however be more permanent, if desired. Dry-release constructions have a weak cohesive bond between two plies so that bond failure easily occurs when they are pulled apart. The surfaces of the dry-release plies are nontacky to the touch. The cling polymer layer or multi-ply construction retained on the storage medium allows it to function as a carrier for the disc and to provide protection to the media side of the disc.

Thus, it should be clear that target area 30 may be formed by a cling polymer layer alone, or a cling polymer layer plus an adhesive including various film and dry-release structures, or an adhesive alone, all within the scope of the present invention.

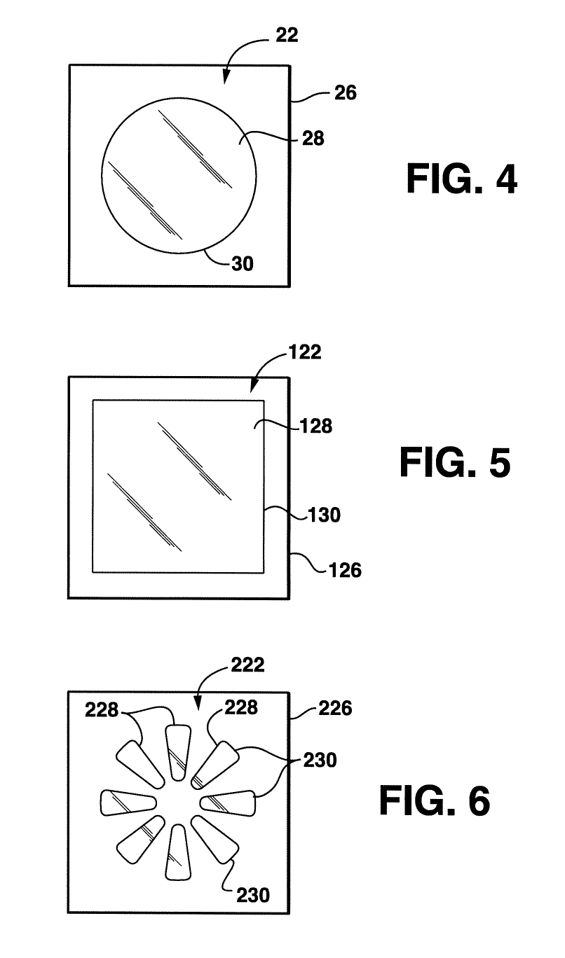

FIG. 5 shows one possible variation of the subject matter of FIGS. 1-4, in which target area 130 is non-circular in shape. Target area 130 may match the outer shape of a utilized data storage medium, or may be larger or smaller. It should be understood that target area 130 is shown as including cling polymer layer 128, but target area 130 may be formed with an adhesive as an addition or alternative, as discussed above.

FIG. 6 shows another possible variation of the subject matter of FIGS. 1-4, in which target area 230 is segmented in shape, rather than continuous. Again, target area 230 is illustrated as being formed of pieces of a cling polymer layer 228, but could be formed using added or alternative adhesives, and could have varying sizes relative to the utilized data storage medium.

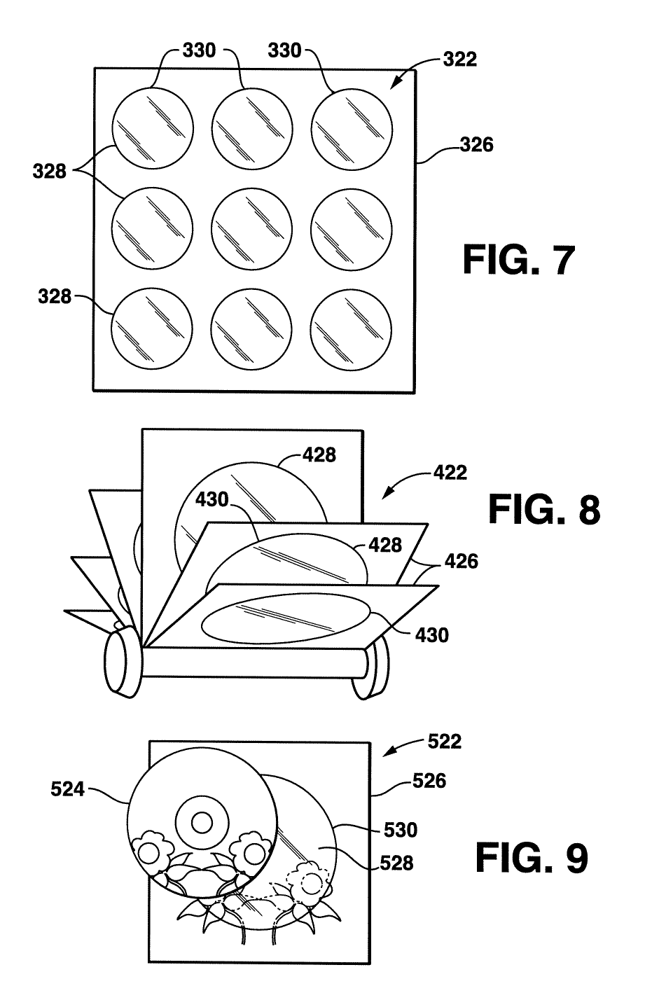

As shown in FIGS. 7 and 8, data storage medium holders may comprise multiple media storage systems of various types. For example, as shown in FIG. 7, substrate 326 includes a plurality of target areas 330. In contrast, as shown in FIG. 8, a plurality of substrates 426 is provided, each with a separate target area 430, forming a disc filing system such as a binder or wallet. If desired, for either example, a protective liner (see FIG. 11) may be provided protecting the cling polymer surface of a target area, removable by user at time of use. In such an embodiment, the user pulls away the protective liner to reveal the target area, which can then be used to retain discs safely and conveniently, with direct accessibility. The user places or presses the disc thereon for individual disc storage and/or group filing with other similarly stored discs on substrates, without the necessity of boxes, jewel cases or envelopes, while also providing the consumer with the ability to conveniently include notation concerning the disc or its content directly onto the substrate which holds the disc or onto its substrate. The stored and filed discs may be removed and replaced onto target areas on the substrates repeatedly. Also, for either embodiment, target areas may be disposed on both sides of each substrate.

As shown in FIG. 9, holder 522 may incorporate various concepts with regard to graphical matter, in combination with that shown on data storage medium 524. Thus, target area 530 may be at least partially translucent so that the substrate 526 portion beneath remains visible, once the disc is removed from the target area. The graphical material beneath may or may not be duplicated by that on the disc. Thus, a “reveal” may be provided by removing data storage medium 524. Said “reveal” may be used for multiple purposes, including marketing communications and even gaming (as in the revelation of a potential prize). Also, either as an alternative or in conjunction, graphical material across substrate 526 and data storage medium 524 may combine to form a single presentation, such as an image, text, etc., if the medium is placed in one or more predetermined orientations. Further, a polymer layer 528 may include graphical material as well. Alternatively, the predetermined orientation may include a random orientation, with graphical material on the disc and substrate 526 forming a combined image in some fashion (for example, if the disc has a symmetrical pattern such as a concentric “target” on it).

Thus, packaging for data storage media is provided which both retains a disc on a “base”, “substrate”, or “carrier” such as direct mail brochures, cards (flat or folded), hang-tags such as those which may hook onto objects (such as doorknobs or other fixtures), as well as those which attach by slipping over (as in the case of an aperture in the substrate slipping over the neck of a bottle), worn on a lanyard (such as those worn around the neck or wrist), attached to consumer goods, or other aesthetic displays, allowing the label side of the disc to be visually incorporated into the display, while at the same time protecting the opposite media side of the disc on the releasable substrate construction. Such provides protection of discs, while allowing discs to be held in place until removed by the user, immediately and easily accessible without the physical barrier of a box or envelope, presenting the disc in a manner which is visually appealing and exciting to the potential user or consumer, while also maximizing the distributor's opportunity for graphic messaging and printed information on packaging. As an example, when compared to a standard 5″×5″ paperboard envelope for the packaging of CDs (the “inside” of which is not imprinted or seen by consumers), a corresponding version utilizing certain of the technology of the present invention provides twice the amount of area for messages to the consumer to be imprinted on the same amount of cardstock, because both sides of the cardstock can be printed, thereby doubling the area for messaging without an increase in the amount of paperboard utilized, and with the added value of allowing additional graphics and information (visible on the disc target area) to be revealed to the consumer upon removal of the disc from the substrate, as well as the information on the disc itself.

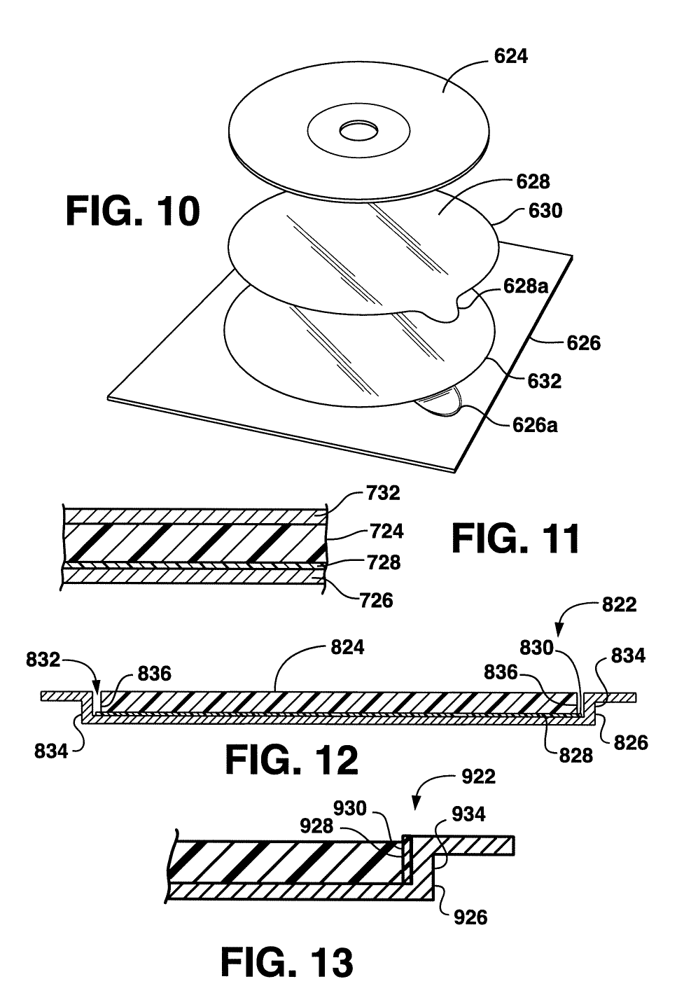

As shown in FIG. 10, substrate and/or polymer layer 628 may include a tab 628a disposed on a portion outside target area 630 which the user may grasp to peel away the material from data storage medium 624. Also, such a tab 628a may be useful to help remove a polymer layer 628 from a separate substrate 626, where the polymer layer is (as in being part of a dry-release or other adhesive construction) or is attached and if desired reattachable to substrate 626. A thumb depression 626a may be provided to assist in removing element 628 from element 626, if desired. Polymer layer 628 may be a cling polymer or may be a multi-layered construction which has cling properties on one side, onto which the disc is placed, and adhesive qualities on its opposite side, by which it is held to a substrate.

In such arrangement, as an option, element 628 may be considered the substrate layer, with element 626 acting as a separate carrier. Element 628 may be formed without a cling polymer layer but with an adhesive, or with a multi-ply-dry release construction, or with both, as described above. Also, the construction of FIG. 10 may be carried out with either releasable and more permanent adhesives, or with the dry-release materials (using layers 628 and 632), as described above.

FIG. 11 illustrates structure(s) suitable for use with any of the embodiments and options described above, once data storage medium 724 is installed on its target area on substrate 726, it may be topped with another layer of material 732 covering fully or partially the disc/substrate composite, or it may be an extension of the substrate, with or without polymer layer 728, cling properties and/or adhesive properties. Material 732 may be separately applied or folded over to cover the disc. If desired, material 732 may be held in place by exposed cling polymer on the substrate, adhesive or pressure sensitive films, thereby creating a package which on one hand functions like an envelope (with top and bottom layers of protections) but which is disassembled by peeling away layers. If desired, upon removal of the data storage medium, the top layer 732 may adhere to the polymer layer 728, thus shielding it from dirt, dust or exposure. Top layer 732 may be a cling polymer or other film, partially or fully opaque, transparent, or translucent, as desired. Thus, substrate 726 may take various forms, including a postcard, an envelope, a folder, a binder, a page or removable insert such as may be bound in a book or magazine, a flat member having an overlay, a pocketed member, a three-dimensionally molded, folded or otherwise constructed shape, a slit member, or a container of any shape (either its exterior or interior surface).

FIG. 12 shows another embodiment of a holder and package according to the other aspects of the invention. As shown, holder 822 includes a substrate 826 having an indentation 832 configured large enough to accommodate a product, such as a data storage medium 824. As an example, substrate 826 may comprise a piece of cardboard or card stock with an embossed indentation forming walls 834. Walls 834 may be continuous or segmented, and may contact the edges 836 of medium 824, or be spaced from the edges. Target area 830 is at the base of the indentation, and may include a polymer layer 828 (as shown) with or without cling polymers, and with or without additional or alternative adhesives, as discussed above. Also, walls 834 may include an extension of polymer layer. Alternatively, substrate 826 may be formed from two or more parts, for example a piece of cardstock adhered to a second piece with an opening formed therethrough to create a substrate with an indentation therein.

Alternatively, substrate 826 could also be molded, cast, or formed unitarily or assembled in various other ways. Substrate 826 could extend just beyond the edges 836 of data storage medium 824 to form a circle or a disc, or could extend further, as shown, in a square shape.

FIG. 13 shows a modification of the structure of FIG. 12, where target area 930, which may include a polymer layer 928 and/or adhesives, is disposed along wall 934.

Thus, with any of the various embodiments above, whether alone or recombined or modified according to the present teachings, upon placement of the media-side of a disc upon the target area, the disc will be retained on the substrate, protecting the media-side from exposure to dirt, dust, and damage. Importantly, storage and protection of media are achieved without the need for an envelope, pocket, sleeve, box, jewel case, or packaging of any type which is reliant upon a hub for retention of disc media.

Further, upon manipulation of the substrate and/or the disc media by the user who wishes to remove the disc, the disc peels away from the target area (substrate and layer) to which it adheres, and releases therefrom easily. The disc can advantageously be removed and replaced repeatedly to display and/or store the media, all the while protecting the underside, or delicate media-side surface of the disc.

Ease of accessibility and of shielding the delicate media-side of the disc are provided, allowing discs to be placed into pockets and bags, for example, without the necessity of envelopes, jewel boxes, or other forms of disc packaging which are bulky and heavy, especially when taken collectively, and manufactured in multiple pieces and complicated and costly to produce, frequently from materials that are subject to easy breakage.

Also, distribution of discs as inserts to books, magazines or other publications is facilitated. Releasable retention of discs on paper, cardstock or other inserts in books, magazines, brochures, or promotional materials, can be provided, until consumers peel them away. The top or label side of the disc is fully visible while retained on the target area, and may be imprinted so as to incorporate the disc into the product, display, graphics or data. Current methods for the insertion of discs to books and magazines involve wrapping or bagging the books or magazines, or other sometimes complex constructions utilizing various forms of envelopes for the discs, many of which cannot be re-utilized after opening by the consumer or create undesirable thickness in magazines.

The present invention thus provides easy and cost-effective storage, protection and distribution of discs, the function of which includes the distribution, handling and storage of blank or recordable disc media, archival storage, filing or protection of recorded discs, including discs for marketing and promotion of a product or services or any other function of media (e.g.: entertainment, information, software, or archival storage).

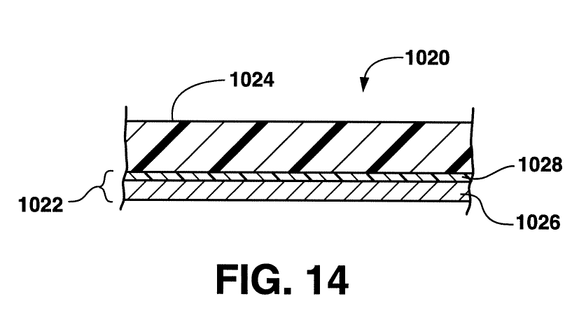

The present invention is not, however, limited to the use with products such as data storage media or discs. Therefore, it should be understood that the present invention has applicability to the packaging and holding of numerous products via cling polymer. FIG. 14 is a broad example of the holding of a product 1024 on a holder 1022, and the resulting package 1020, made possible by virtue of the teachings of the present invention. FIG. 14 shows diagrammatically in a broad sense one example of a substrate 1026, a cling layer 1028, and a product 1024 according to certain aspects of the invention. These elements may comprise any of the elements mentioned above, and it should be understood that FIG. 14 is representative only and the actual form and arrangement of the illustrated elements could change according to the application. The possibilities for use of the present invention are so broad that illustrating the full scope of options would be impossible. Accordingly, countless applications are possible within the scope of the present invention, and the specific mention of any one application herein is merely an example and not to be considered limiting.

For example, some of the products cling polymer layer may be used to retain include, for example, glass, plastics, metals, ceramics and other non-porous, smooth materials which may comprise part of or be wholly the exterior surface of products, or may be products which have an outer layer, as may be provided by labeling, shrink-wrapping, or other element of packaging, to which the cling polymer layer adheres. Such products (whether full size, samples or components of products) may include: cosmetics, fragrances, pharmaceuticals, medical products (including those requiring a sterile packaging environment) and various items in the health and beauty category, watches, jewelry, coins, souvenirs and collectibles, electronic devices including phones, cell phones, MP3 players, (and accessories for the aforementioned), other electronics and electronic components including circuit boards, transistors, hearing aids, microphones, cameras, and screens, housewares, all types of jars or bottles (including alcoholic beverages) food, spices, gourmet items, components, parts and other items relating to product assembly, manufacturing and industry, plastic or plasticized cards (such as credit cards, ID cards and gift cards), clothing and accessories, tools, lighting products, alarms, keys, hardware for general utilization (or specialty utilization as in packages of small, fine components for the creation of arts, crafts, or hobbies), or a presentation device for products for promotional purposes (including direct mail) and other consumer goods. The cling polymer layer may be adhered directly to such products or the products may, if necessary for adherence to the cling layer, be sleeved or otherwise partially or fully packaged in a suitable material so as to have a surface such that it adheres to the cling layer.

Other applications could include data storage devices such as a disc, a flash drive, a memory stick, an encased or enveloped storage media such as a UMD Disc, music or video players or communications devices having solid state memory, disc drives or flash drives, MP3 players, devices to make such data storage devices carryable or wearable, including pockets, clips or hangers, use with flexible pliable foam like composites having the cling material on an outer portion thereof so as to be pressable or nestable therein, merchandizing hang tags or other displays such as those which may hook onto objects (such as doorknobs or other fixtures), be adhesively adhered to objects, as well as those which attach by slipping over (as in the case of an aperture in the substrate slipping over the neck of a bottle), or be otherwise attached to chains, belts, tapes or strings so as to hang as would a medallion or the like on a person or object, gaming devices, trading cards, lottery tickets, or magnetic substrates for further attachment to magnetic objects for display, information or safety.

The present invention therefore relates to packaging for products which may be sleeved, enveloped or encased in smooth, non-porous materials (e.g.: eyeshadow in a compact case, or pharmaceuticals in a blister-pack or dispenser), or which may have a non-porous exterior (e.g.: personal electronic appliances such as a Palm Pilot, collectible items such as coins or medallions), or have some other surface of which when pressed against a material, surface or other packaging construction which is coated or covered with vinyl or other polymer providing cling retention, results in the safe retention of the product against the surface without the use of fugitive glue or other temporary, light tack or removable adhesives.

The holder and package may be used for consumer goods and other products, retaining the product in the desired position inside a package, keeping it from rattling or otherwise moving inside the package, thus aiding to insure in its protected transport and/or so as to create an aesthetically pleasing presentation upon opening the package. The present invention is not limited to packaging for any type, size or form of product or component of a product, and here hereafter collectively referred to as “products” or “consumer products”.

The material composing the package or substrate providing physical structure to the interior of the package may be made of any suitable manmade or natural material(s), such as paper, plastic, metal, glass, ceramic or combinations thereof. The shape of the interior surface of the package may be coordinately shaped to receive the product (e.g. flat to receive a product which has a flat side, or concave to accept a product which is relatedly convex). The substrate of the interior package surface may be malleable, so that its surface shape may mold or change to accept and/or conform with the product pressed upon it.

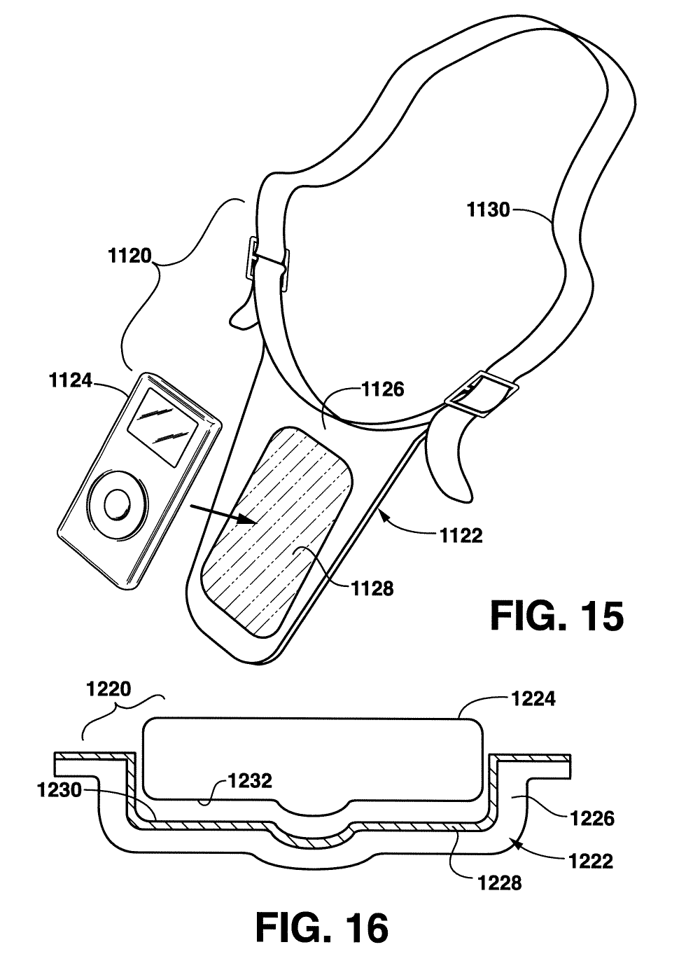

Further illustrative examples of holders and packages for products are shown in FIGS. 15-18. It should be understood that these examples are merely illustrative, and no exclusion of any product, holder or package is intended by virtue of the inclusion of these examples.

As depicted, FIG. 15 is a perspective view of a first example of one application of the concepts of FIG. 14, wherein a product comprising a portable music player is attached to a holder. As shown, attaching a product 1124 to a holder 1122, including a substrate 1126 and a cling layer 1128, creates a package 1120. As shown, product 1124 is a portable music device such as an mp3 player. Holder 1122 includes a loop 1130 that may comprise a handle or hanger, as shown. Loop 1130 may be adjustable via buckles, snaps, hook-and-loops fasteners, etc., if desired. Other shapes and types of carrying elements could be substituted for loop 1130, if such functionality were desired, with this or any of the embodiments herein.

FIG. 16 is a cross-sectional view of an example of a holder and product wherein the cling polymer layer is pre-formed to be non-planar. As indicated, holder 1222 includes cling layer 1228 having a non-planar surface 1230. The shaping may be achieved before or after cling layer 1228 is attached to substrate 1226, and by various methods and from various materials. Substrate 1226 could therefore be paperboard, styro-foam, metal or plastic, and could comprise an inner or outer portion of an item, or even another product. As shown, a contact surface 1232 of product 1224 conforms to the shape of contact surface 1230 of the cling layer, which can improve the attachment in some applications.

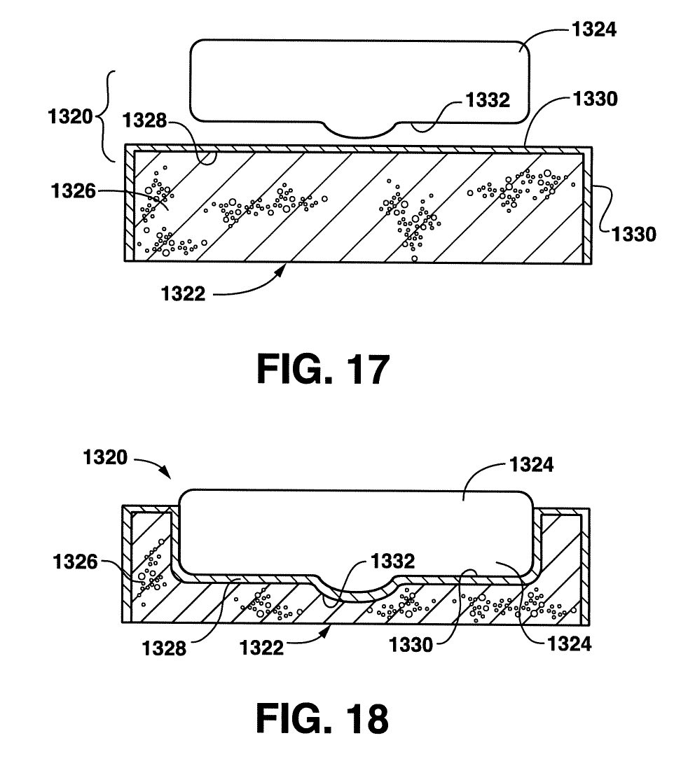

FIGS. 17 and 18 are cross-sectional views of an alternate example of a holder and product wherein the cling-polymer layer is non-planar, where the non-planar shape is formed via contact with the product. As shown, product 1324 has an irregular contact surface 1332. Cling layer 1328 has a planar or other shaped contact surface 1330 not conforming to the contact surface 1332 prior to attachment. As shown in FIG. 17, surface 1330 is substantially flat. After application of product 1324, substrate 1326 is compressed to allow cling layer surface 1330 to conform to the shape of surface 1332 of product 1324. Substrate 1326 could be permanently or temporarily compressed by the contact, as desired, and could be made of various solid, or liquid or gel-like materials, and in various ways. Cling layer 1328 may also be on only part of the substrate 1326, such as in the form of strips or dots of cling material which serve to hold the product in place. (See FIG. 6).

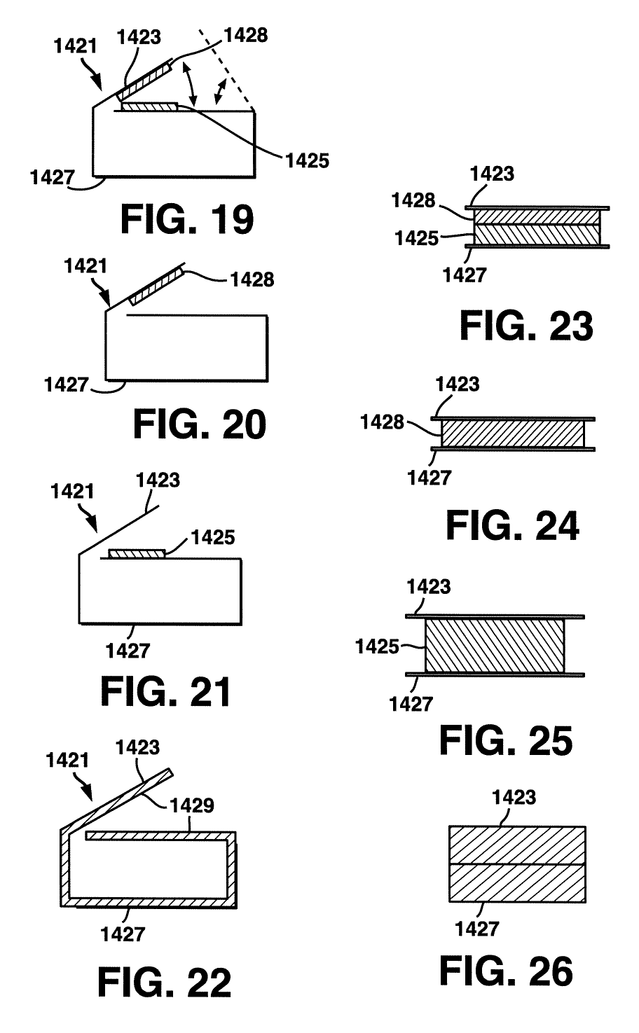

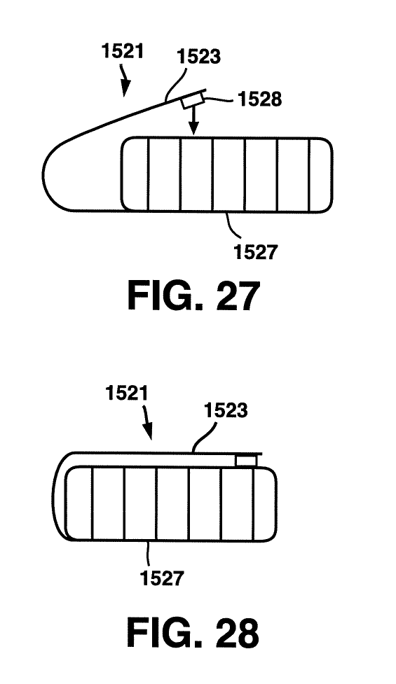

In each of the examples shown in FIGS. 14-18, any of the options and modifications mentioned previously may be applied to arrive at further embodiments and vice-versa. Further, the embodiments of FIG. 19-39 may also be combined with those of FIGS. 1-18 to arrive at further examples within the scope of the invention.

As shown, the cling polymer may be disposed as a film or layer on at least a portion of the surface of the substrate, as a target area for receipt of the product. Preferably, the target area, contiguously or in segments covers an area that is large enough, in proportion to the product, so that application of the product to the target area results in the retention of the product to the target area. The target area may be smaller than, equal to or greater in size than the product that it will receive. In one aspect, the cling layer is disposed on the entire surface of the substrate. In another aspect, the target area is shaped coordinately with the product it receives. In yet another aspect, the polymer may comprise the entire body of the package, all or a portion of which may have cling properties to serve as a target area for the retention of the product.

A suitable adhesive to attach the cling layer to the substrate may be used. Preferably, clear cling polymer, either directly, or as a top or exposed layer in a multi-layered construction, will be adhered to the substrate utilizing an adhesive that is likewise transparent or translucent, so as to allow graphics and information printed on the substrate or substrate construction to be clearly viewable.

Upon placement of the product upon the target area of the cling layer, the product is held to the cling layer which retains it on the substrate, protecting the product from movement inside the package, thus aiding to insure against damage which could result from such movement. The present invention achieves storage and protection of products in such packaging without the utilization of fugitive glue or other adhesives, which are sticky to the touch and sometimes leave a sticky residue on the product or on the interior surface of the package. The cling layer in the construction is preferably, though not necessarily, at least partially translucent so that substrate beneath remains visible, once the product is removed from target area.

Further, upon manipulation of the substrate and/or the product by the user who wishes to remove the product, the product peels away from the target area (substrate and cling layer), and releases therefrom easily. The holding capability of the substrate is not measurably reduced with repeated use, unlike traditional adhesives, and offering a functionality which is impossible utilizing fugitive glue. Therefore, the product can be removed and replaced repeatedly to display and/or store the product inside the protective packaging. The present invention provides the advantages of ease of accessibility, of the non-sticky retention of products in packaging, and of the lack of residue such as that left on products by adhesives including fugitive glue.

In another aspect, a system for releasably adhering disc media, cards, products, samples coupons or other products is provided which both retains the product within an advertisement or other aesthetic display, for instance in a page or insert of a magazine. Products can be held in place until removed by the user, easily accessible without the barrier of a box or envelope, visually appealing and exciting to the potential user or consumer.

The present disclosure provides easy and cost-effective storage, protection and distribution of products or product samples which are handed out or otherwise distributed, the function of which may be product sampling, advertising, marketing or promotion of a product or services, or any other function of product premiums.

In another aspect, a packaging system comprises a plurality of substrates grouped together, each substrate having a cling polymer layer for removably receiving at least one product. The stored and filed products may be removed and replaced onto the substrates, such as cards, repeatedly.

Therefore, it should be understood, that use of cling polymer material can be used in various diverse ways to hold products, thereby forming a package. The present invention is thus not limited to any type of product, holder or resulting package, according to the above teachings.

A system for closure of products or packaging, or for the fugitive retention of data, products, or any number of substrates to a target, utilizing in whole or in part one or more layers of a cling polymer (such as cling vinyl) is disclosed which can provide one or all of a variety of desired functions: fugitive hold, a clean non-sticky surface, flatness, evenness, visual integration with the design of the substrate, package or product, visual clarity (allowing the printing or graphics of the substrate, or of products themselves, to be viewable through it), and ability to both release cleanly and, if desired, re-adhere. Cling polymers for such purposes may be any size and can be configured to be flat or any desired three dimensional shape; they may have cling holding qualities on one or both sides; they may be clear or any color, transparent, translucent or opaque; they may be the sole component or one component of a multiple component composite (such as in a windowed overlay construction). Furthermore, cling polymer holding qualities may be present on all surfaces of the material, or on just a portion of it. Cling polymer holding qualities may be a contiguous aspect of the material, object, data, product, package or closure, or a material having cling polymer holding qualities in whole or in part may be applied thereto via lamination, casting, molding, spraying, utilizing cohesive constructions or adhesives, either directly or in a composite form.

According to certain aspects, holders and closures may incorporate cling vinyl to create a means of closure in packaging or other products, or a means of restraining objects in packaging, providing a protective overlay which simultaneously restrains product placement, or provides a means of removable attachment and/or reattachment of a given object or substrate to any other object(s) or substrate(s).

For example, a box may be configured with a flap which may be comprised of a cling polymer material, or it may have a cling polymer layer placed on it, so as to adhere the flap to a second cling polymer layer (target) on the body of the box, when the flap is pressed down upon the target area. Alternatively, the cling polymer layer on the flap may come in contact with a surface comprised of any other material to which the cling polymer layer will adhere (not necessarily a second cling polymer layer). Alternatively, the cling polymer layer or properties may be on the body of the box, and/or it may be continuous or segmented. The target surface area of the flap may be comprised of any material to which the cling polymer will adhere, which also may be contiguous or segmented. Also, the target area may be any size, including the option of being as large as the surface area of the product. The box, its flap or any substrate may include one of a natural material product, a paper product, a polymer product, a synthetic product, or combinations thereof. Optionally, an adhesive substance may be used in tandem with the cling polymer on either surface of it. Obviously, innumerable variations and modifications are possible, the essential element of the system being the fugitive utility of cling polymers to provide fugitive means of retention or closure which may be clean, non-sticky, novel, and attractive.

The system for product or packaging closure or retention may include a plurality of target areas so as to provide functional alternatives for closure or retention, aesthetic design or for any reason at all. Also, the cling polymer targets may include a plurality of pieces spaced from each other. The pieces may be disposed laterally with respect to one another, and/or the product, product holder or package may include a plurality of substrates, any number of which may be comprised of a cling polymer or have a cling polymer layer disposed on it.

If desired only the cling polymer layer secures closure of a package or product, or retention of an object, including printed, digital or electronic data, in packaging, or retention of a product in packaging. Alternatively, the cling polymer layer may be either releasably or permanently adhered (either directly or in layers) to a substrate, a package or a component of a package, or the cling polymer layer may itself be the package. The cling polymer layer may be permanently or removably attached to the substrate, or plurality of substrates, or it may comprise all of the substrate, or any part of it.

The use of a cling polymer in a system for closure in packaging or retention of objects (including any form of printed, digital or electronic data) to a target may further include one of a multi-ply dry-release construction, a cohesive film construction, a fugitive adhesive, a light tack or other adhesive construction, or a plurality of cling polymers adhering one to the other or in any combination commingled with other films, polymers, man-made or natural substrates, or any combination of such constructions which may include a cling polymer. The cling polymer layer alone, or the cling polymer/substrate construction, may be removably attachable and reattachable to a product, package or other target. It may be comprised of a cling polymer, a cling polymer/substrate construction, a plurality of cling polymers or cling polymer layer/substrate constructions, or a cling polymer layer or layers together with any other material. Furthermore, the cling polymer layer may be attached to the substrate using adhesive as a bonding agent between the cling polymer layer and the substrate. Alternatively, the cling polymer layer may be joined to the substrate via casting, coating, spraying, lamination, compression or other method which may create either a removable/non-reaffixable, removable/reaffixable, removable/fugitively reaffixable or non-removable relationship between the cling polymer layer and a natural or man-made substrate.

Also, the cling polymer layer may be non-planar, whether pre-formed or so formed during use as a closure or retention mechanism, or upon application of a product or other object, including written, digital or electronic data or substrates thereto.

In use as a system for closure or retention, cling polymer may separate from its target in a 180 degree peel force test immediately after placement of the product upon the target at about 15 grams. The peel force may increase with dwell time to about 50 grams or more. A cling polymer has two surfaces, one or both of which may be utilized for its cling qualities. In the case of a cling polymer being adhesively adhered to a substrate, its top or exposed surface provides cling qualities which may be utilized in creating closure in a product or packaging, or retention of a product or data thereto. Alternatively, the cling holding qualities of either surface may be capped or protectively covered by a removable liner.

Closure, adherence or retention may occur between one surface having cling polymer properties in whole or in part and a target, between two or more surfaces having cling polymer qualities in whole or in part in contact with one another, or between one or more such surfaces and one or more targets. Closure, adherence or retention may occur due to direct contact of a product to a cling polymer (such as a plastic credit card fugitively adhered to a cling polymer surface, which has been permanently adhesively adhered to a paper substrate), or closure, adherence or retention may occur due to a cling polymer overlay, creating either a partial or complete encasement, serving to restrain the object in packaging or to a target area. An example of such a form of retention would be a plastic card on a non-porous paper substrate, both of which are covered by a cling polymer layer. Such overlays may also be wholly comprised of a cling polymer, or a cling polymer may constitute part of the overlay, contiguously or segmented.

As a protective carrier or packaging for products (which may include CDs, DVDs and other forms of disc media, but is not limited to such products) a cling polymer layer may have cling-holding qualities on either one or both surfaces, or the cling polymer layer may be adhesively adhered to a substrate, or it may be printed on one or both surfaces. In the example in which one surface is printed, such printing may be done in layers, with an optional flood coat between sets of layers in printing, achieving what may be either a mirror image, the same image or a different graphic or message when viewed from each side. In the case of a cling polymer layer having cling-holding qualities on both surfaces, while one surface may serve to hold or retain the product in position, the other surface may be removably affixed to a substrate, or series of substrates which may be comprised of any type of man-made or natural materials, including cling polymers. The product and the cling polymer which holds it in position may be removable as a unit. In yet another embodiment, a cling polymer construction which has cling-holding qualities on one or both surfaces, may be a composite of two cling polymer layers, one or both of which may be printed on their adjoining sides, joined with or without adhesives, with the possibility of a third or multiple layers placed between them which may be comprised of a polymer or natural material and which may or may not be printed; the two or more layers adhered to one other so as to comprise a composite material which has cling holding qualities on one or both sides, and which may be printed.

The product carrier, whether comprised of a single cling layer or a composite of cling polymer(s) and/or other substrates, may have a hole. For example, in the case in which such packaging is assembled with a standard CD, DVD or other disc media, the hole may correspond with the center hole in such discs. This optional hole in packaging may provide the functionality of 1) making the packaged products (such as packaged discs) stackable on a center pole (as seen in “cake-box” type bulk disc packaging, commonly used to distribute discs to both consumers and within the industry), or 2) allowing a cord or other filament to loop through the hole, providing a means of hanging the packaged product, or otherwise attaching it to any other object, or to be worn as a medallion or tag. Whether or not a product adhered to packaging utilizing a cling polymer has a center hole or not, a product thus packaged may be attached to products or packages as a tag, an insert, an “on-pack” (packaged in tandem with another product or products by attachment to it or its packaging), or packed inside of any other type of consumer product or packaging; or it may be displayed, or worn.

The product carrier may also take the form of a folder, mailer, or other package in which the utilization of cling polymer(s), being smooth, lightweight and not bulky, provide fugitive retention of products, without hindering the ability of the folder, mailer or other package to be processed automatically; a feature which would be attractive to postal systems as well as other entities to whom the ability to utilize high speed processing and sorting equipment is vital to their operations. Important to the functionality of such folders, mailers or packages would be any design wherein lateral planes are restrained to only move in tandem (and not in opposing directions). An example of a functional dimension for a direct mail piece containing a CD or DVD held in place by a cling polymer is 9.5″×5″. Such folders, mailers or other packages may also utilize a cling polymer in their system of closure.

Non-limiting examples of these additional concepts are set forth in FIGS. 19-39. In particular, FIGS. 19-22 are sectional views of packages with a flap and a hinged side, showing alternative closure systems, with FIGS. 23-26 respectively comprising enlarged views of portions of FIGS. 19-22. In FIG. 19, package 1421 includes a flap 1423 releasably adhered by a cling polymer layer 1428 on the flap 1423 when it is joined to a correspondingly placed cling polymer layer 1425 on the package body 1427. An additional flap (shown in dotted lines) could be included to fold into, under or over flap 1423, if desired. In FIG. 20, layer 1425 is omitted, whereas in FIG. 21, layer 1428 is omitted. In FIGS. 20 and 21, the respective surfaces of the package body 1427 or flap 1423 that contact the cling polymer layers 1428 or 1425 may be made of a material to which cling polymers provide an acceptable hold. In FIG. 22, the entire package body 1427 and flap 1423 may have cling polymer 1429 holding qualities, or any part of the flap may have such properties, as may any part of the package surface coming in contact with the flap in its closed position. Thus, FIGS. 19-26 are intended to provide non-limiting examples of use of cling polymer material to secure part of products together so as to form a package.

FIGS. 27 and 28 are sectional views representing any of the packages of FIGS. 19-22, modified with a longer and flexible flap 1523, attachable continuously at various points on the package body 1527 surface, thus expanding or contracting the size of the package 1521. Any of the polymer arrangements of FIGS. 19-22 could be employed, in connection with the continuously variable attachment concept of FIGS. 27-28, although layer 1528 attaching to body 1527 is illustrated by way of example.

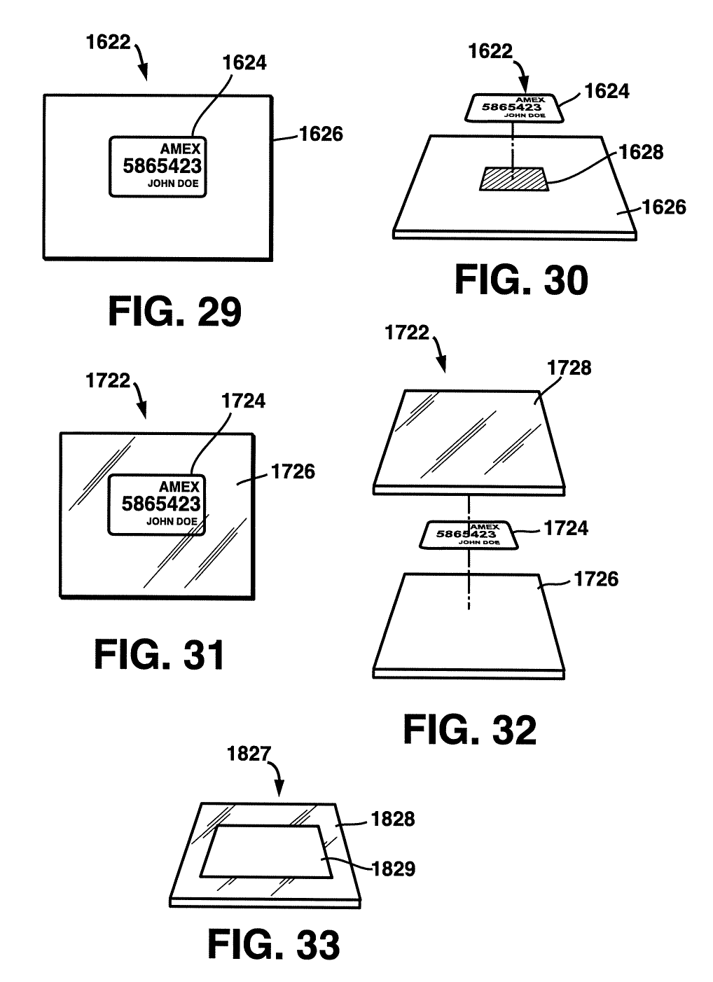

FIGS. 29 and 30 are respectively a top view and an exploded perspective view of a product holder 1622 showing the relationship between a product 1624 (in this case, a plastic credit card), as it is held by a cling polymer layer 1628 to a substrate (package) 1626. The cling polymer layer 1628 has been adhesively attached to the substrate 1626, creating a target area for product placement and fugitive retention.

FIGS. 31 and 32 are respectively a top view and an exploded perspective view of a product holder 1722 showing the relationship between a product 1724 (in this case, a plastic credit card), as it is held to a substrate (package) 1726 by a cling polymer overlay 1728 which covers the credit card and extends beyond the size of the credit card, makes contact with the surface of the substrate (package), thus encapsulating the credit card and restraining it in position on the carrier/substrate (package). Such an overlay 1728 may be composed entirely of a cling polymer, or it may be a composite of any other material and a cling polymer placed so as to functionally provide fugitive restraint of the product by the overlay. Overlay 1728 may be transparent, translucent, or opaque, and may have printing on an outer (upper, as shown) surface, and may be utilized in relationship to the product and substrate as illustrated in FIG. 31 (without a cling layer below the product) or as illustrated in FIG. 30 (with a cling layer below the product). FIG. 33 shows a modification of the overlay of FIGS. 31 and 32, in which overlay 1827 includes a cling polymer portion 1828 and a non-cling window portion 1829. Alternately, all of overlay 1827 could be cling polymer material, with differences in transparency and/or printing between parts such as 1828 and 1829 or others.

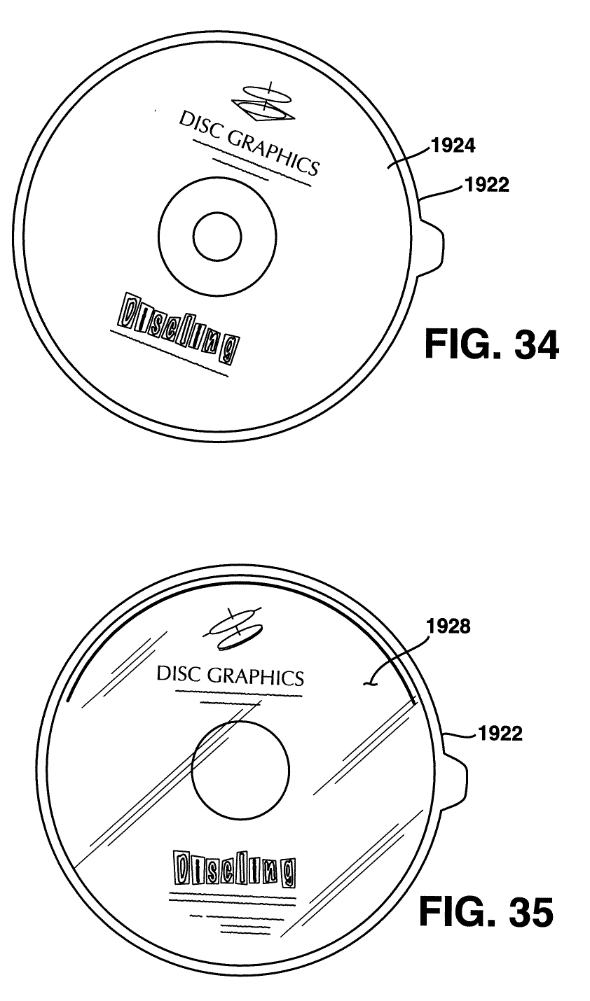

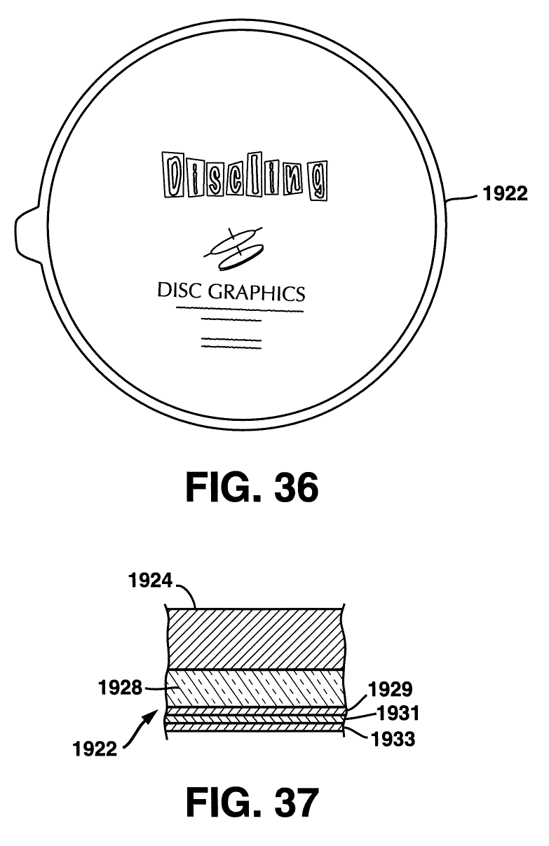

FIGS. 34-37 are top views of a product holder 1922 comprised of a transparent cling polymer carrier for use with a product 1924 (in this case, a compact disc). FIG. 34 shows holder 1922 attached to disc 1924 from the “disc” side. So situated, colorful graphics and information printed on the reverse side of the cling polymer 1928 (the side not attached to the disc) are visible around the edges of the disc, and coordinate with the disc when it is assembled upon the holder 1922. FIG. 35 shows the holder 1922 with the disc 1924 removed, thereby providing a reveal of the graphics on the holder that had been beneath the disc. FIG. 36 shows the reverse side of the holder 1922, revealing a different graphic. This effect can be achieved by use of layers: a first graphical layer visible through the cling side (FIG. 35), a “flood coat” layer or other visual separator which serves to create an opaque quality or backing from either side, and then a second graphical layer to achieve the graphic seen on the reverse side of the carrier (FIG. 36). FIG. 37 shows a cross-section of the holder 1922, showing the cling material 1928 attached to the disc 1924, a first layer of graphics 1929 visible on the “cling” side through material 1928, a flood coat 1931, and a second layer of graphics 1933 visible on the side opposite the “cling” side. It should be understood that the graphics layers need not be continuous or cover the entire holder 1922. Alternately, either of the graphical layers and/or flood coat could be eliminated, providing differing cling polymer holders for covering the disc with or without messages visible from one or both sides.

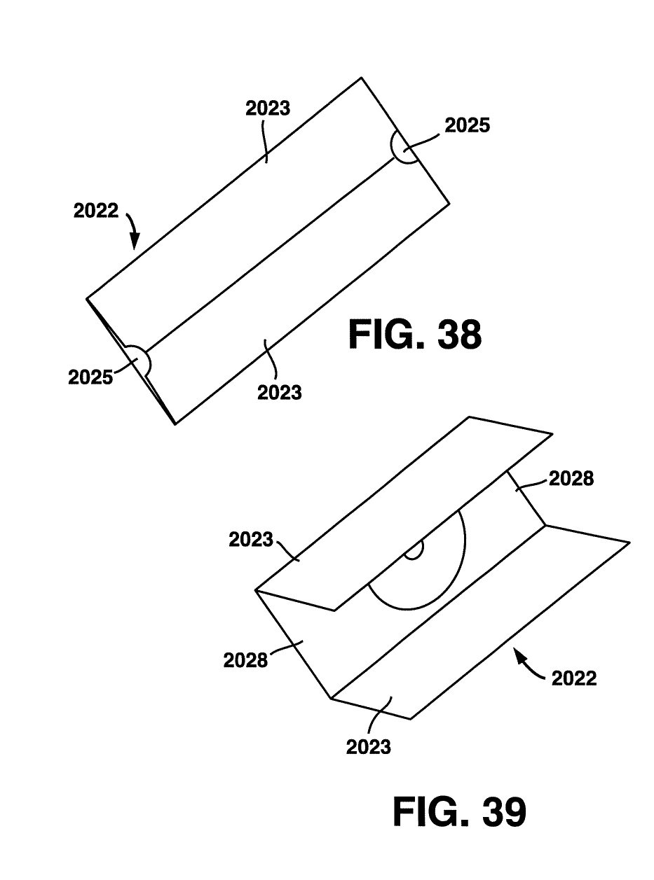

FIGS. 38 and 39 respectively show a closed (assembled) and open view of one of many configurations of a product holder 2022, in this case a direct mail piece holding a CD 2024, approximately 9.5 inches long by 5 inches high. Cling material 2028 on holder 2022 holds the disc in place, and may be used to hold flaps 2023 in place as well. Wafer seals 2025 may be used additionally or instead to hold flaps 2023 down. By restraining the lateral planes (the plane of the product carrier and any planes lateral to it), the product carrier can be sorted using automated postal sorting equipment, to the extent to which the product(s) being carried by the product holder are of a size and/or sufficient flexibility to also withstand the size and/or flexibility requirements of such systems. The same effect (restraint of lateral planes) can be achieved by enveloping a product carrier, or by the lamination or cling adherence of an overlay covering the disc and some portion of the substrate.

It will be apparent to those skilled in the art that various modifications and variations can be made in the present invention without departing from the scope and spirit of the invention. For example, specific shapes of various elements of the illustrated embodiments may be altered to suit particular applications. It is intended that the present invention include such modifications and variations as come within the scope of the appended claims and their equivalents.

I claim:

1. A holder for a product, the holder comprising:
a substrate; and
a cling polymer layer permanently attached to at least a portion of the substrate, the cling polymer layer having an outer surface defining a target area configured for releasably securing the product to the substrate via a non-adhesive, cling hold to the cling polymer layer, the cling polymer layer including a plasticizer and having a smooth finish in at least the target area, without tactile stickiness, whereby the product may be repeatedly pressed onto and removed from the target area, the cling polymer layer non-adhesively securing the product to the substrate for handling as a unit, the cling polymer layer configured such that removal of the product from the cling polymer layer does not produce tactile residue on either the product or the substrate.

2. The product holder of claim 1, wherein the cling polymer layer includes a vinyl or a polyester.

3. The product holder of claim 1, wherein the cling polymer layer is at least partially translucent or transparent, whereby the substrate is at least partially visible through the cling polymer layer.

4. The product holder of claim 3, wherein the substrate includes graphical material and the product is releasably positioned in reference to the graphical material via the cling polymer, whereby removal of the product reveals the graphical material.

5. The product holder of claim 4, wherein removal of the product completes a visual message.

6. The product holder of claim 1, wherein the product and the substrate include graphical material configured to co-operatively form a single presentation when the product is attached to the target area in a predetermined orientation.

7. The product holder of claim 1, wherein only the cling polymer layer secures the product to the substrate.

8. The product holder of claim 1, wherein the substrate defines a three-dimensional shape configured for receiving the product and protecting an outer edge of the product holder.

9. The product holder of claim 1, wherein the product and the cling polymer layer material separate in a 180 degree peel force test initially at about 15 grams and after dwell time at as much as 50 grams or more.

10. The product holder of claim 1, wherein the substrate includes one of a direct mail brochure, a flat or folded card, or a book, magazine or publication insert, page or cover.

11. The product holder of claim 1, wherein the product includes a first side for contacting the cling polymer target area and a second side opposite the first side, and the substrate includes a portion configured to contact the product on the second side.

12. The product holder of claim 11, wherein the substrate comprises one or more of an envelope, a folder, a binder, a flat member having an overlay, a pocketed member, a slit member, a lid, a box, or other container.

13. The product holder of claim 12, wherein the cling polymer layer holds the portion of the substrate in place relative to the product as a closure.

14. The product holder of claim 1, wherein the product comprises an optical disc.

15. The product holder of claim 1, wherein the product comprises a plastic or plasticized card such as a credit card, ID card or gift card.

16. The product holder of claim 1, wherein the product comprises an item held during a commercial process.

17. A package comprising:
a product;
a substrate; and
a cling polymer layer permanently attached to at least a portion of the substrate, the cling polymer layer having an outer surface defining a target area configured for releasably securing the product to the substrate via a non-adhesive, cling hold to the cling polymer layer, the cling polymer layer including a plasticizer and having a smooth finish in at least the target area, without tactile stickiness, whereby the product may be repeatedly pressed onto and removed from the target area, the cling polymer layer non-adhesively securing the product to the substrate for handling as a unit, the cling polymer layer configured such that removal of the product from the cling polymer layer does not produce tactile residue on either the product or the substrate.

18. The package of claim 17, wherein the cling polymer layer includes a vinyl or a polyester.

19. The package of claim 17, wherein the data storage medium comprises an optical disc.

20. The package of claim 17, wherein the product comprises a plastic or plasticized card such as a credit card, ID card or gift card.

21. The package of claim 17, wherein the product comprises an item held during a commercial process.

22. A holder for a product, the holder comprising:
a cling polymer layer, the cling polymer layer being at least partially translucent or transparent and having a first surface defining a target area configured for releasably securing to the product via a non-adhesive, cling hold to the cling polymer layer, the cling polymer layer including a plasticizer and having a smooth finish in at least the target area, without tactile stickiness, whereby the product may be repeatedly pressed onto and removed from the target area, the cling polymer layer non-adhesively securing the product to the substrate for handling as a unit, the cling polymer layer configured such that removal of the product from the cling polymer layer does not produce tactile residue on either the product or the substrate;
a first graphical layer disposed on a second surface of the cling polymer layer;
a flood layer disposed on and providing a visual backing for the first graphical layer so that the first graphical layer is readable only through the first surface of the cling polymer layer when the cling polymer layer is removed from the product; and
a second graphical layer disposed on the flood layer visible from the second surface of the cling polymer layer, whereby opposite sides of the holder may provide different graphical messages via the first and second graphical layers, visually separated by the intervening flood layer.

23. The product holder of claim 22, wherein the cling polymer layer includes a vinyl or a polyester.

24. The product holder of claim 22, wherein the data storage medium comprises an optical disc.

25. The product holder of claim 22, wherein the product comprises a plastic or plasticized card such as a credit card, ID card or gift card.

26. A package comprising:
a substrate having a body and a movable portion, the movable portion movable between an opened and a closed position; and
a cling polymer layer permanently attached to at least a portion of at least one of the body or the movable portion, the cling polymer layer having an outer surface defining a target area configured for releasably securing the movable portion to the body via a non-adhesive, cling hold to the cling polymer layer, the cling polymer layer including a plasticizer and having a smooth finish in at least the target area, without tactile stickiness, whereby the movable portion may be repeatedly pressed onto and removed from the target area, the cling polymer layer non-adhesively securing the movable portion to the body as a closure, the cling polymer layer configured such that opening of the closure layer does not produce tactile residue on either the movable portion or the body.

27. The package of claim 26, wherein the cling polymer layer includes a vinyl or a polyester.

28. The package of claim 26, wherein the substrate comprises one or more of an envelope, a folder, a binder, a flat member having an overlay, a pocketed member, a slit member, a lid, a box, or other container.

29. The package of claim 26, wherein the substrate holds a product secured by the closure.

30. The package of claim 29, wherein the product is secured to the substrate via cling polymer material.

31. A holder for a product, the holder comprising:
a cling polymer layer having an outer surface defining a target area sized and configured for releasably securing to the product via a non-adhesive, cling hold to the cling polymer layer, the cling polymer layer including a plasticizer and having a smooth finish in at least the target area, without tactile stickiness, whereby the product may be repeatedly pressed onto and removed from the target area, the cling polymer layer non-adhesively attaching to the product for handling as a unit, the cling polymer layer configured such that removal of the product from the cling polymer layer does not produce tactile residue on the product.

32. The product holder of claim 31, wherein the cling polymer layer includes a vinyl or a polyester.

33. The product holder of claim 31, wherein the product and the cling polymer layer material separate in a 180 degree peel force test initially at about 15 grams and after dwell time at as much as 50 grams or more.

34. The product holder of claim 31, wherein the product comprises an optical disc.

35. The product holder of claim 31, wherein the product comprises a plastic or plasticized card such as a credit card, ID card or gift card.

36. The product holder of claim 31, wherein the product comprises an item held during a commercial process.
